(19) United States
(12) Patent Application Publication
(10) Pub. No.: US 2017/0014850 A1
(43) Pub. Date: Jan. 19, 2017

(54) ARTICULATED NOZZLE AND WATER DISPLAY SYSTEM AND METHOD

(71) Applicant: Crystal Fountains Holdings Inc., Concord (CA)

(72) Inventors: George Ayer, Concord (CA); David Barratt, Concord (CA)

(21) Appl. No.: 15/209,877

(22) Filed: Jul. 14, 2016

Related U.S. Application Data
(60) Provisional application No. 62/192,320, filed on Jul. 14, 2015.

(51) Int. Cl. B05B 15/06; B05B 12/08; B05B 17/08

(52) U.S. Cl. CPC B05B 15/067; B05B 17/08; B05B 12/08

(57) ABSTRACT

A system and method for producing a fluid display are provided. The method and system involve providing a bendable fluid flow path, the bendable fluid flow path i) having a central axis, ii) being bendable such that the central axis is bendable to define curves in non-parallel planes at different portions along a bendable portion of the bendable fluid flow path, and iii) having an upstream end and a downstream end. Fluid from the downstream end of the bendable fluid flow path can be provided to a nozzle from which the fluid flow can exit in a fluid flow path direction.

### RELATED APPLICATIONS

This application claims priority from the U.S. Patent Application No. 62/192,320 filed on Jul. 14, 2015 entitled “ARTICULATED NOZZLE AND WATER DISPLAY SYSTEM AND METHOD”, the disclosures of which are incorporated herein by reference.

### FIELD

The present invention relates to an articulated water nozzle system.

### BACKGROUND

Systems and devices for moving a water stream exiting via a water nozzle are known. Known systems and devices provide a certain range of movement for the water stream, but lack the ability to provide movement in three degrees of freedom, where one of the degrees of freedom is a function of a flexible member supporting the water nozzle. Further, known systems and devices lack the ability to accurately track and continuously calibrate the position, velocity, and acceleration of the water nozzle, both relative to itself and relative to other water nozzles in the system.

### SUMMARY

In accordance with an aspect of an embodiment of the invention, there is provided an articulated nozzle system. The system may comprise a bendable conduit for providing a bendable fluid flow path. The bendable fluid flow path may have a central axis. The bendable fluid flow path may also be bendable such that the central axis may be bendable to define curves in non-parallel planes at different portions along a bendable portion of the bendable fluid flow path. The bendable fluid flow path may further have an upstream end and a downstream end. The upstream end may comprise a fluid coupler for coupling the upstream end to a fluid source to receive a fluid flow from the fluid source.

The system may further comprise a nozzle for receiving the fluid flow from the bendable fluid flow path. The nozzle may also provide a nozzle fluid flow path in fluid communication with the bendable fluid flow path. The nozzle may have a first end and a second end. The first end may be mounted to the downstream end of the bendable fluid flow path. The nozzle may comprise a nozzle axis extending between the first end and the second end of the nozzle. The nozzle axis may be coincident with the central axis at the first end of the nozzle. The nozzle may further comprise a nozzle outlet at the second end of the nozzle. The nozzle outlet may define a nozzle outlet plane perpendicular to the nozzle axis. The nozzle axis may define a fluid flow path direction at the nozzle outlet plane. The fluid flow may exit the nozzle outlet in the nozzle fluid flow path direction. The nozzle may further comprise a nozzle tip at the intersection point of the nozzle axis and the nozzle outlet plane.

The system may further comprise a nozzle positioning controller for moving the nozzle. The nozzle positioning controller may move the nozzle by rotating the nozzle around a first axis, pivoting the nozzle by an angle of deflection from the first axis, and bending the bendable fluid flow path. The angle of deflection may be measurable in a plane orthogonal to a plane of rotation of the nozzle around the first axis. Any given position of the nozzle tip and the nozzle fluid flow path direction may be definable as a combination of the deflection and rotation of the nozzle and the bending of the bendable portion of the bendable fluid flow path.

In accordance with a further aspect of an embodiment of the invention, the system may further comprise a plurality of sensors for tracking the nozzle. The plurality of sensors may be configured to transmit sensor signals to the nozzle positioning controller. The nozzle positioning controller may be configured to receive the sensor signals. The nozzle positioning controller may further be configured to determine the position of the nozzle tip and the nozzle fluid flow path direction based, at least in part, on the sensor signals. The nozzle positioning controller may further be configured to move the nozzle based on the determined position of the nozzle tip and the determined nozzle fluid flow path direction.

In accordance with a further aspect of an embodiment of the invention, the bendable conduit may be a flexible conduit that is bendable at any point along a bendable portion of its length.

In accordance with a further aspect of an embodiment of the invention, the nozzle positioning controller may comprise at least three driving mechanisms and a plurality of connectors. One end of each connector may be coupled to one of the at least three driving mechanisms. The other end of each connector may be coupled to the nozzle. Each connector may be coupled to a different one of the at least three driving mechanisms.

In accordance with a further aspect of an embodiment of the invention, the connectors may be offset from each other in a circumferential direction around the nozzle axis at the nozzle.

In accordance with a further aspect of an embodiment of the invention, the connectors may be positioned relative to each other to apply corresponding forces to the nozzle that are offset by about 120 degrees.

In accordance with a further aspect of an embodiment of the invention, the plurality of connectors may be cables.

In accordance with a further aspect of an embodiment of the invention, each of the at least three driving mechanisms may comprise a spool. Each of the plurality of cables may have a first portion and a second portion. The first portion of each cable may be wrapped around the spool of the driving mechanism to which it is coupled. The second portion of each cable may extend between the spool and the nozzle. The driving mechanisms may be operable to change a length, a rate of change of length, and a rate of rate of change of length of the second portion of each cable.

In accordance with a further aspect of an embodiment of the invention, the nozzle positioning controller may be configured to operate the driving mechanisms to determine the length, the rate of change of length, and the rate of rate of change of length of the second portion of each cable. The length, the rate of change of length, and the rate of rate of change of length of the second portion of each cable may be definable such that any one or more of the length, the rate of change of length, and the rate of rate of change of length of the second portion of any one of the plurality of cables may be different than the length, the rate of change of length, and the rate of rate of change of length of the second portion of any other of the plurality of cables.

In accordance with a further aspect of an embodiment of the invention, the plurality of connectors may be push rods.

In accordance with a further aspect of an embodiment of the invention, each driving mechanism may be operable to change a position, a velocity, and an acceleration of each push rod.

In accordance with a further aspect of an embodiment of the invention, the nozzle positioning controller may be configured to operate the driving mechanisms to determine the position, the velocity, and the acceleration of each of the plurality of push rods. The position, the velocity, and the acceleration of each push rod may be definable such that any one or more of the position, the velocity, and the acceleration of any one of the plurality of push rods may be different than the position, the velocity, and the acceleration of any other of the plurality of push rods.

In accordance with a further aspect of an embodiment of the invention, the articulated nozzle system may be configured such that a maximum angle of deflection of the nozzle from the first axis is about 50°.

In accordance with a further aspect of an embodiment of the invention, the sensor signals may comprise at least one magnetometer reading, at least one gyroscopic reading, and at least one accelerometer reading. The plurality of sensors may comprise at least one magnetometer for measuring the at least one magnetometer reading, at least one gyroscope for measuring the at least one gyroscopic reading, and at least one accelerometer for measuring the at least one accelerometer reading. The nozzle positioning controller may be configured to determine the position of the nozzle tip and the nozzle fluid flow path direction based on the at least one magnetometer reading, the at least one gyroscopic reading, and the at least one accelerometer reading.

In accordance with a further aspect of an embodiment of the invention, the nozzle positioning controller may be configured to compare the at least one magnetometer reading with the at least one gyroscopic reading and the at least one accelerometer reading to calibrate the nozzle fluid flow path direction.

In accordance with a further aspect of an embodiment of the invention, the nozzle positioning controller may be operable such that different nozzle fluid flow path directions may be definable for a given position of the nozzle tip by bending the bendable portion of the bendable fluid flow path into different configurations.

In accordance with a further aspect of an embodiment of the invention, the plurality of sensors may be mounted on the nozzle. The nozzle positioning controller may be operable to determine the position of the nozzle tip and the nozzle fluid flow path direction based in part on, for at least one cable in the plurality of cables, a length of the second portion of that cable.

In accordance with a further aspect of an embodiment of the invention, there is provided a fluid display system. The fluid display system may comprise a plurality of articulated nozzle systems. The articulated nozzle systems may each comprise a bendable conduit for providing a bendable fluid flow path. The bendable fluid flow path may have a central axis. The bendable fluid flow path may also be bendable such that the central axis may be bendable to define curves in non-parallel planes at different portions along a bendable portion of the bendable fluid flow path. The bendable fluid flow path may further have an upstream end and a downstream end. The upstream end may comprise a fluid coupler for coupling the upstream end to a fluid source to receive a fluid flow from the fluid source.

The articulated nozzle systems may each further comprise a nozzle for receiving the fluid flow from the bendable fluid flow path. The nozzle may also provide a nozzle fluid flow path in fluid communication with the bendable fluid flow path. The nozzle may have a first end and a second end. The first end may be mounted to the downstream end of the bendable fluid flow path. The nozzle may comprise a nozzle axis extending between the first end and the second end of the nozzle. The nozzle axis may be coincident with the central axis at the first end of the nozzle. The nozzle may further comprise a nozzle outlet at the second end of the nozzle. The nozzle outlet may define a nozzle outlet plane perpendicular to the nozzle axis. The nozzle axis may define a fluid flow path direction at the nozzle outlet plane. The fluid flow may exit the nozzle outlet in the nozzle fluid flow path direction. The nozzle may further comprise a nozzle tip at the intersection point of the nozzle axis and the nozzle outlet plane.

The articulated nozzle systems may each further comprise a nozzle positioning controller for moving the nozzle. The nozzle positioning controller may move the nozzle by rotating the nozzle around a first axis, pivoting the nozzle by an angle of deflection from the first axis, and bending the bendable fluid flow path. The angle of deflection may be measurable in a plane orthogonal to a plane of rotation of the nozzle around the first axis. Any given position of the nozzle tip and the nozzle fluid flow path direction may be definable as a combination of the deflection and rotation of the nozzle and the bending of the bendable portion of the bendable fluid flow path.

The articulated nozzle systems may each further comprise a plurality of sensors for tracking the nozzle. The plurality of sensors may be configured to transmit sensor signals to the nozzle positioning controller. The nozzle positioning controller may be configured to receive the sensor signals. The nozzle positioning controller may further be configured to determine the position of the nozzle tip and the nozzle fluid flow path direction based, at least in part, on the sensor signals. The nozzle positioning controller may further be configured to move the nozzle based on the determined position of the nozzle tip and the determined nozzle fluid flow path direction.

The fluid display system may further comprise a fluid display system controller. The fluid display system controller may be configured to receive the sensor signals from each of the plurality of articulated nozzle systems. The fluid display system controller may further be configured to determine the position of the nozzle tip and the nozzle fluid flow path direction of each of the plurality of articulated nozzle systems based, at least in part, on the sensor signals of that articulated nozzle system. The fluid display system controller may further be configured to move the nozzle of each of the plurality of articulated nozzle systems based on the determined position of that nozzle tip and the determined position of at least one other nozzle tip, and based on the determined nozzle fluid flow path direction of that articulated nozzle system and the determined nozzle fluid flow path direction of at least one other articulated nozzle system.

In accordance with a further aspect of an embodiment of the invention, there is provided a method of producing a fluid display. The method may comprise providing a bendable fluid flow path. The bendable fluid flow path may have a central axis. The bendable fluid flow path may be bendable such that the central axis may be bendable to define curves in non-parallel planes at different portions along a bendable portion of the bendable fluid flow path. The bendable fluid flow path may also have an upstream end and a downstream end.

The method may further comprise providing a nozzle fluid flow path with a first end a second end. The first end of the nozzle fluid flow path may be in fluid communication with the downstream end of the bendable fluid flow path. The nozzle fluid flow path may have a nozzle fluid flow path axis extending between the first end and the second end of the nozzle fluid flow path. The nozzle fluid flow path axis may be coincident with the central axis at the first end of the nozzle fluid flow path. The nozzle fluid flow path may further have a nozzle fluid flow path outlet at the second end of the nozzle fluid flow path. The nozzle fluid flow path outlet may define a nozzle fluid flow path outlet plane perpendicular to the nozzle fluid flow path axis. The nozzle fluid flow path axis may define a nozzle fluid flow path direction at the nozzle fluid flow path outlet plane. The nozzle fluid flow path may further have a nozzle fluid flow path tip at the intersection point of the nozzle fluid flow path axis and the nozzle fluid flow path outlet plane.

The method may further comprise connecting the upstream end of the bendable fluid flow path to a fluid source. The method may further comprise providing a fluid flow from the fluid source to the nozzle fluid flow path outlet via the bendable fluid flow path and the nozzle fluid flow path. The fluid flow may exit the nozzle fluid flow path outlet in the nozzle fluid flow path direction.

The method may further comprise moving the nozzle fluid flow path. Moving the nozzle fluid flow path may comprise rotating the nozzle fluid flow path axis around a first axis. Moving the nozzle fluid flow path may further comprise pivoting the nozzle fluid flow path axis by an angle of deflection from the first axis. Moving the nozzle fluid flow path may further comprise bending the bendable fluid flow path. The angle of deflection may be measurable in a plane orthogonal to a plane of rotation of the nozzle fluid flow path axis around the first axis. Any given position of the nozzle fluid flow path tip and the nozzle fluid flow path direction may be definable as a combination of the deflection and rotation of the nozzle fluid flow path axis and the bending of the bendable portion of the bendable fluid flow path.

In accordance with a further aspect of an embodiment of the invention, the method may further comprise determining a position of the nozzle fluid flow path tip and the nozzle fluid flow path direction. The method may further comprise moving the nozzle fluid flow path based on the determined position of the nozzle fluid flow path tip and the determined nozzle fluid flow path direction.

In accordance with a further aspect of an embodiment of the invention, a maximum angle of deflection of the nozzle fluid flow path axis from the first axis is about 50°.

In accordance with a further aspect of an embodiment of the invention, different nozzle fluid flow path directions may be definable for a given position of the nozzle fluid flow path tip by bending the bendable portion of the bendable fluid flow path into different configurations.

In accordance with a further aspect of an embodiment of the invention, there is provided a method of producing a fluid display. The method may comprise providing a plurality of bendable fluid flow paths. Each bendable fluid flow path may have a central axis. Each bendable fluid flow path may be bendable such that the central axis may be bendable to define curves in non-parallel planes at different portions along a bendable portion of the bendable fluid flow path. Each bendable fluid flow path may also have an upstream end and a downstream end.

The method may further comprise providing a plurality of nozzle fluid flow paths with a first end a second end. The first end of each nozzle fluid flow path may be in fluid communication with the downstream end of one of the bendable fluid flow paths. Each nozzle fluid flow path may have a nozzle fluid flow path axis extending between the first end and the second end of the nozzle fluid flow path. The nozzle fluid flow path axis may be coincident with the central axis at the first end of the nozzle fluid flow path. Each nozzle fluid flow path may further have a nozzle fluid flow path outlet at the second end of the nozzle fluid flow path. The nozzle fluid flow path outlet may define a nozzle fluid flow path outlet plane perpendicular to the nozzle fluid flow path axis. The nozzle fluid flow path axis may define a nozzle fluid flow path direction at the nozzle fluid flow path outlet plane. Each nozzle fluid flow path may further have a nozzle fluid flow path tip at the intersection of the nozzle fluid flow path axis and the nozzle fluid flow path outlet plane.

The method may further comprise connecting the upstream end of each bendable fluid flow path to a fluid source. The method may further comprise providing a fluid flow from the fluid source to each nozzle fluid flow path outlet via the bendable fluid flow path and the nozzle fluid flow path. The fluid flow may exit each nozzle fluid flow path outlet in the nozzle fluid flow path direction of that nozzle fluid flow path. The method may further comprise determining a position of each nozzle fluid flow path tip and each nozzle fluid flow path direction.

The method may further comprise moving each nozzle fluid flow path based on the determined position of that nozzle fluid flow path tip and the determined position of at least one other nozzle fluid flow path tip, and based on the determined nozzle fluid flow path direction of that nozzle fluid flow path and the determined nozzle fluid flow path direction of at least one other nozzle fluid flow path. Moving each nozzle fluid flow path may comprise rotating the nozzle fluid flow path axis around a first axis. Moving each nozzle fluid flow path may further comprise pivoting the nozzle fluid flow path axis by an angle of deflection from the first axis. Moving each nozzle fluid flow path may further comprise bending the bendable fluid flow path. The angle of deflection may be measurable in a plane orthogonal to a plane of rotation of the nozzle fluid flow path axis around the first axis. Any given position of each nozzle fluid flow path tip and each nozzle fluid flow path direction may be definable as a combination of the deflection and rotation of each nozzle fluid flow path axis and the bending of the bendable portion of each bendable fluid flow path.

In accordance with a further aspect of an embodiment of the invention, the method may further comprise calibrating the position of each nozzle fluid flow path tip and each nozzle fluid flow path direction. Calibration may be done by moving each nozzle fluid flow path such that each nozzle fluid flow path tip may be positioned at a pre-determined nozzle fluid flow path tip position, and each nozzle fluid flow path direction may be oriented at a pre-determined nozzle fluid flow path direction orientation.

### DRAWINGS

The person skilled in the art will understand that the drawings, described below, are for illustration purposes only. The drawings are not intended to limit the scope of the applicants' teachings in any way.

FIG. 1A illustrates a top-oriented isometric view of an articulated nozzle system according to an embodiment of the present invention.

FIG. 1B illustrates a top-oriented isometric view of an articulated nozzle system according to an embodiment of the present invention.

FIG. 2A illustrates a partial interior view of an articulated nozzle system according to an embodiment of the present invention.

FIG. 2B illustrates a partial interior view of an articulated nozzle system according to another embodiment of the present invention.

FIG. 2C illustrates a partial interior view of an articulated nozzle system according to another embodiment of the present invention.

FIG. 3 illustrates a bottom-oriented isometric view of an articulated nozzle system according to an embodiment of the present invention.

FIG. 4 illustrates an exploded assembly view of an articulated nozzle system according to an embodiment of the present invention.

FIG. 5 is a block diagram representing a functional configuration of the nozzle positioning controller according to an embodiment of the present invention.

FIG. 6 is a block diagram representing a functional configuration of the nozzle positioning controller according to an embodiment of the present invention.

FIG. 7 is a block diagram representing a functional configuration of the nozzle positioning controller according to an embodiment of the present invention.

FIG. 8 is a block diagram representing a functional configuration of the fountain controller according to an embodiment of the present invention.

### DESCRIPTION OF EMBODIMENTS

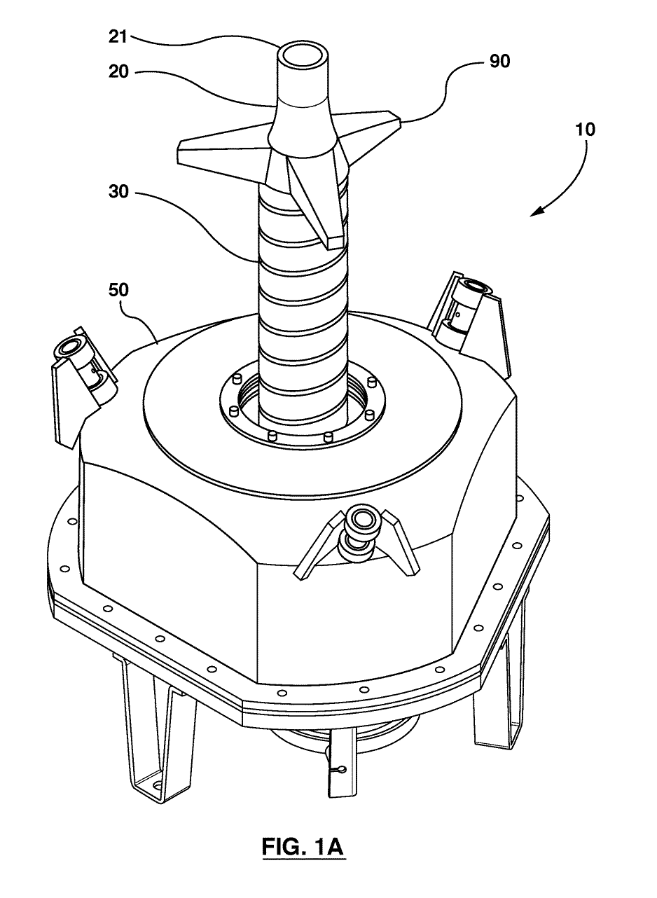

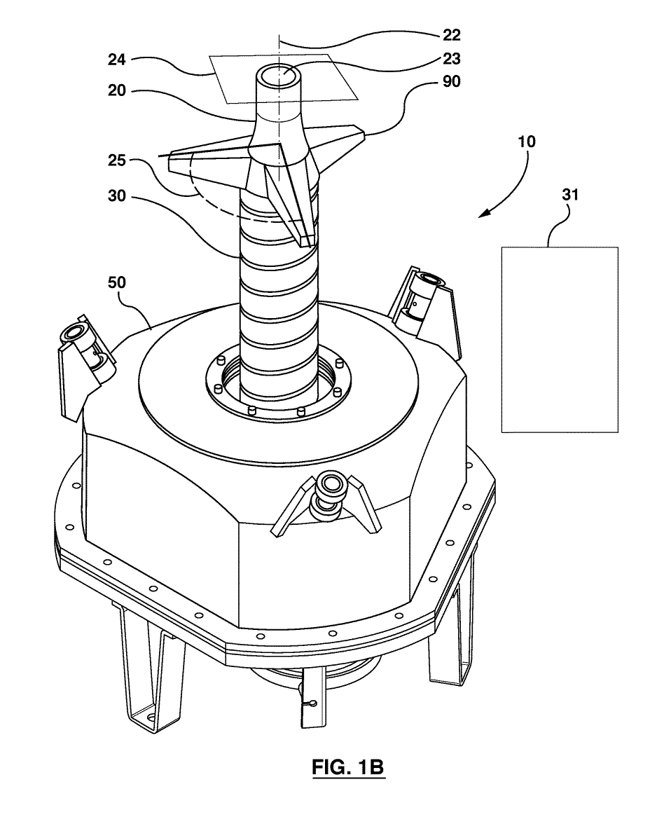

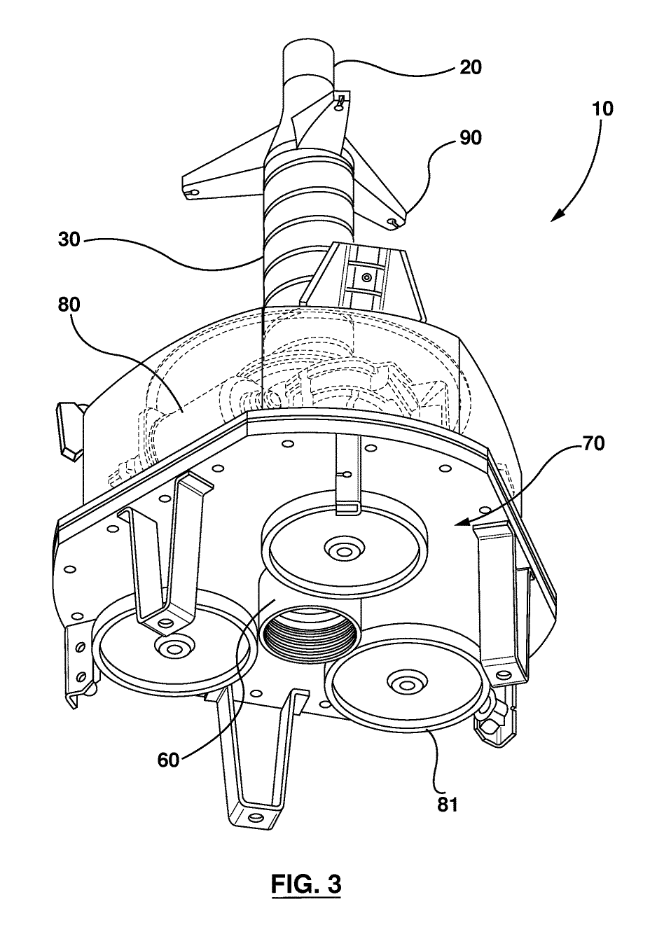

Referring to FIGS. 1-4, an articulated nozzle system 10 is illustrated, which may comprise a moveable nozzle 20 for fountains. In order to produce the desired visual effects, the articulated nozzle system 10 may project a stream of fluid upward. The fluid may be water. The articulated nozzle system 10 may vary the direction, elevation, and intensity of the stream of fluid.

In one embodiment, fluid may be supplied to the articulated nozzle system 10 at a pressure of about 11 psi. At this pressure, a stream of fluid may be expelled from the nozzle 20 at a flow rate of about 80 gpm, and the elevation of the stream of fluid may be about 20 feet.

In another embodiment, fluid may be supplied to the articulated nozzle system 10 at a pressure of about 23 psi. At this pressure, a stream of fluid may be expelled from the nozzle 20 at a flow rate of about 120 gpm, and the elevation of the stream of fluid may be about 30 feet.

In another embodiment, fluid may be supplied to the articulated nozzle system 10 at a pressure of about 37 psi. At this pressure, a stream of fluid may be expelled from the nozzle 20 at a flow rate of about 150 gpm, and the elevation of the stream of fluid may be about 45 feet.

In another embodiment, fluid may be supplied to the articulated nozzle system 10 at a pressure of about 48 psi. At this pressure, a stream of fluid may be expelled from the nozzle 20 at a flow rate of about 175 gpm, and the elevation of the stream of fluid may be about 55 feet.

The direction of the stream of fluid can be changed by changing the tilt and rotation of the nozzle 20 and by bending a bendable conduit 30. In one embodiment, the bendable conduit 30 may comprise a flexible hose. The flexibility of the hose may allow the bendable conduit 30 to bend in a manner described more fully herein. In another embodiment, the bendable conduit 30 may comprise a plurality of relatively inflexible sections. The sections may be connected to each other via ball and socket couplings that permit pivoting of each section relative to its adjoining sections. The pivoting of each section may allow the bendable conduit 30 to bend in a manner described more fully herein.

In one embodiment, the bendable portion of the bendable conduit 30 may be constrained by a collar 40. In another embodiment, the bendable portion of the bendable conduit 30 may be further constrained by a housing 50. The non-constrained portion of the bendable conduit 30 may be bendable such that a central axis 32 of the bendable conduit 30 may define curves in non-parallel planes at different portions along the non-constrained portion.

The nozzle 20 may have an outlet 21 for expelling a stream of fluid and an inlet for receiving a supply of fluid via a physical concentric connection with the bendable conduit 30. In one embodiment, the connection between the bendable conduit 30 and the nozzle 20 may comprise a ball or ball and socket joint. In another embodiment, the connection between the bendable conduit 30 and the nozzle 20 may comprise a universal joint. The bendable conduit 30 may be fluidly connected to a fluid source 31 via a fluid coupler 60.

In one embodiment, the nozzle 20 may have a bore diameter of about one inch.

The bendable conduit 30 may be mounted at the centre of a base 70. The collar 40 may also be mounted onto the base, surrounding a portion of the bendable conduit 30.

In one embodiment, the base 70 may comprise at least three mounts surrounding the bendable conduit 30. The at least three mounts may form obtuse angles, in a horizontal plane, in relation to each other. The obtuse angle may be 120 degrees. A driving mechanism 80 may be mounted on each mount.

In another embodiment, the base may comprise a single mounting surface, with at least three driving mechanisms 80 mounted on the surface.

In one embodiment, the driving mechanisms 80 may be selectively rotatable motors, such as a servo motor or a stepper motor. In another embodiment, the driving mechanisms 80 may be linear actuators, such as a hydraulic or pneumatic piston. A nozzle positioning controller 82 may control the at least three driving mechanisms 80.

In one embodiment, the minimum speed of a driving mechanism 80 that is a selectively rotatable motor is about 60 rpm.

The outlet 21 and the inlet of the nozzle 20 may each define a circular opening. The circular openings may be concentric, and may be communicably linked such that fluid supplied to the inlet of the nozzle 20 is expelled from the outlet 21 of the nozzle 20. A line connecting the centroids of the circular openings may define a nozzle axis 22. Fluid may be expelled from the outlet 21 of the nozzle 20 in a direction defined by the nozzle axis 22 at the outlet 21. The nozzle axis 22 may be coincident with the central axis 32 of the bendable conduit 30 at the inlet of the nozzle 20.

The bendable conduit 30 may have an upstream end and a downstream end. The inlet of the nozzle 20 may be mounted onto the downstream end of the bendable conduit 30, such that fluid flowing through the bendable conduit 30 from the upstream end to the downstream end will continue to flow through to the inlet of the nozzle 20. The bendable conduit 30 may receive a fluid flow from a fluid source 31 via the fluid coupler 60 that may couple the upstream end of the bendable conduit 30 to the fluid source 31. In one embodiment, the bendable conduit 30 and the nozzle 20 may extend vertically upward from the base. This position may be defined as the nozzle's unbiased, or neutral, position. In this position, the bendable conduit 30 may define a neutral axis.

A secondary collar 90 may be connected by a plurality of connectors 100 to the at least three driving mechanisms 80. Each connector 100 may connect the secondary collar 90 to only one of the at least three driving mechanisms 80. The secondary collar 90 may define a circular opening for receiving the inlet of the nozzle 20. The secondary collar 90 may be mounted onto the inlet of the nozzle 20, and the top end of the bendable conduit 30 may be mounted onto the inlet of the nozzle 20 below the secondary collar 90. In one embodiment, the connectors 100 may be offset from each other around the secondary collar 90 in a circumferential direction. In a further embodiment, the connectors 100 may be offset from each other by connector offset angle 25 of about 120 degrees.

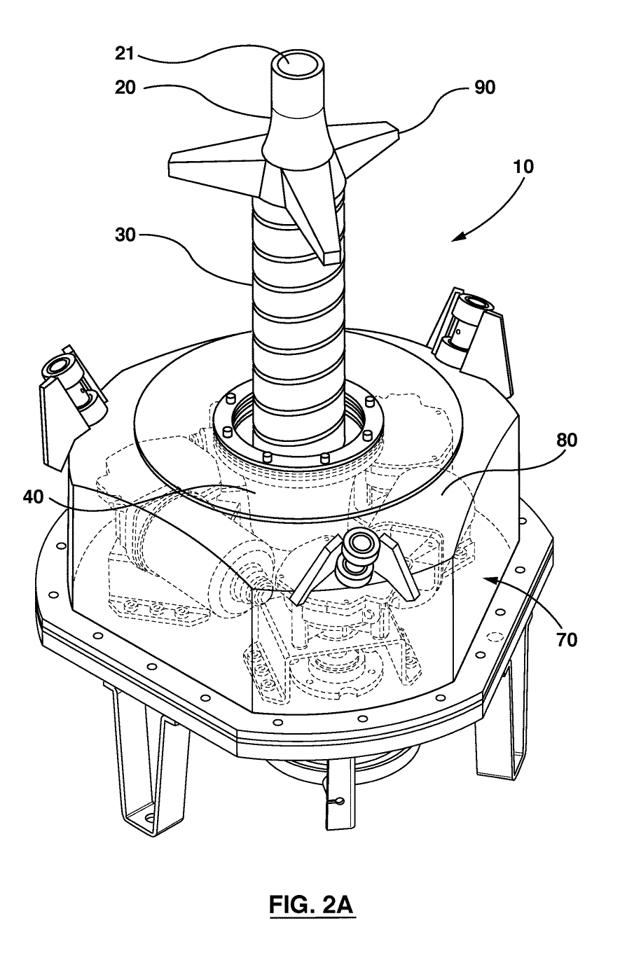

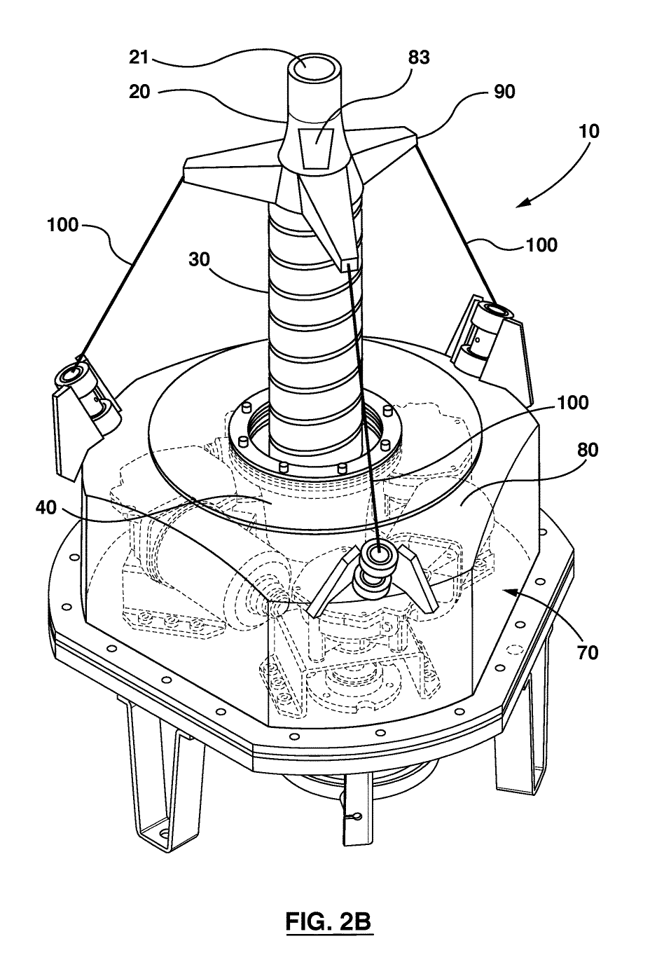

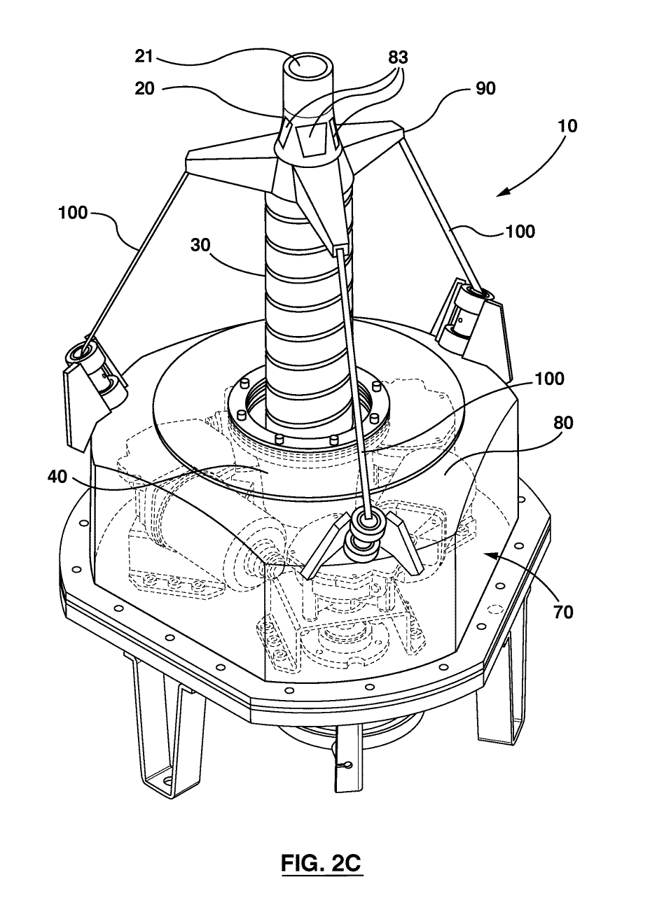

Referring to FIG. 2B, in one embodiment, the connectors 100 may comprise cables. In this embodiment, the driving mechanisms 80 may each comprise a spool 81. The cables may be wrapped around the spool 81, such that an effective portion of the cable may extend between the spool 81 and the secondary collar 90, while the remainder of the cable may remain wrapped around the spool 81.

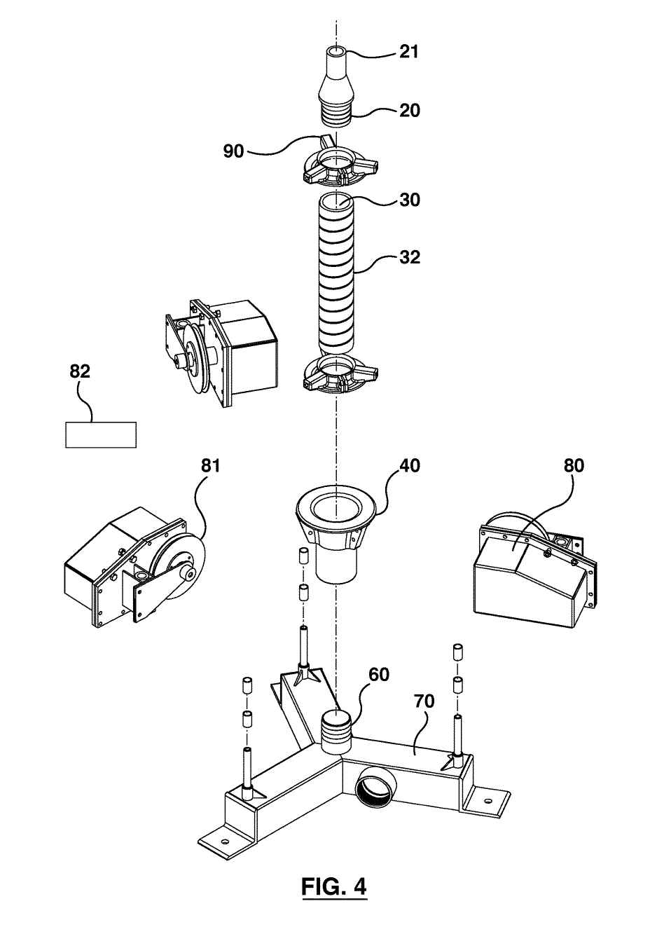

Referring to FIG. 4, the spool 81 may be mounted atop the base 70. In another embodiment, referring to FIGS. 1-3, the spool 81 may be mounted below the base 70.

The nozzle positioning controller 82 may selectively actuate the driving mechanisms 80 so as to change the effective length of each cable. Changing the effective length of the cable may apply a force to the nozzle 20, causing it to be displaced from its position. The nozzle positioning controller 82 may be pre-programmed such that the sequence of actuations of the driving mechanisms 80 is determined in advance.

The nozzle positioning controller 82 may operate the driving mechanisms 80 so as to change the effective length of each cable at a certain rate. The nozzle positioning controller 82 may further operate the driving mechanisms 80 so as to change the rate of change of the effective length of each cable at a certain rate. Accordingly, the nozzle positioning controller 82 may, at any point, determine the effective length, the rate of change of the effective length, and the rate of rate of change of the effective length of each cable. The nozzle positioning controller 82 may control each driving mechanism 80 separately, such that the change, rate of change, and rate of rate of change of the effective length of each cable may be different. Controlling the rate of change and the rate of rate of change of the effective length of each cable may move the nozzle 20 such that water is expelled from the nozzle outlet 21 in an interesting and creative display.

Referring to FIG. 2C, in another embodiment, the connectors 100 may comprise push rods, which may be driven by driving mechanisms 80 that are linear actuators. In an alternative embodiment, each of the connectors 100 may comprise a crank and piston mechanism, which may be driven by driving mechanisms 80 that are selectively rotatable motors. Other types of connectors known in the art may also be used.

The nozzle positioning controller 82 may selectively actuate the driving mechanisms 80 so as to change the position of each push rod or piston. Changing the position of the push rod or piston may apply a force to the nozzle 20, causing it to be displaced from its position. The nozzle positioning controller 82 may be pre-programmed such that the sequence of actuations of the driving mechanisms 80 is known in advance.

The nozzle positioning controller 82 may operate the driving mechanisms 80 so as to change the velocity and acceleration of each push rod or piston. Accordingly, the nozzle positioning controller 82 may, at any point, determine the position, velocity, and acceleration of each push rod or piston. The nozzle positioning controller 82 may control each driving mechanism 80 separately, such that the change in position, velocity, and acceleration of each push rod or piston may be different. Controlling the velocity and acceleration of each push rod or piston may move the nozzle 20 such that water is expelled from the nozzle outlet 21 in an interesting and creative display.

The nozzle positioning controller 82 can operate the driving mechanisms 80 so as to apply one or more forces to the nozzle 20. The forces applied to the nozzle 20 may provide an angular deflection of the nozzle 20 from the neutral axis, a rotation of the nozzle 20 about the neutral axis, and bending of the bendable conduit 30. The position and orientation of the nozzle 20 can then be partially described as an angle in a vertical plane between the neutral axis and the nozzle axis 22 (the tilt of the nozzle 20), and an angle of rotation of the nozzle axis 22 in a horizontal plane around the neutral axis. The position and orientation of the nozzle 20 may be fully described by the inclusion of the shape of bending of the bendable conduit 30.

In one embodiment, the maximum tilt of the nozzle 20 in any direction may be about 50 degrees, and the angle of rotation in a horizontal plane about the central axis 32 may be between 0 and 360 degrees.

The number of degrees of freedom of a system is equal to the number of independent variables required to describe the system's state at any given point in time. The motion of the nozzle 20 may occur in three dimensions based on three independent variables:

1) angle of deflection of the nozzle 20 from the neutral axis,
2) angle of rotation of the nozzle 20 about the neutral axis, and
3) shape of bending of the bendable conduit 30.

Therefore, three variables may be required to define the position of a point on the nozzle 20.

As described above, any given position and orientation of the nozzle 20 may define a unique tilt and angle of rotation of the nozzle 20, as well as a unique bending shape of the bendable conduit 30. In turn, any given position and orientation of the nozzle 20 may be defined by the independent actuations of the three driving mechanisms 80.

Therefore, a given set of actuations may define a unique tilt and angle of rotation of the nozzle 20 and bending shape of the bendable conduit 30. In other words, the three variables required to describe a tilt and angle of rotation of the nozzle 20 as well as the bending shape of the bendable conduit 30 may be the independent actuations of the first, second, and third driving mechanisms 80. The direction of the fluid stream exiting the nozzle outlet 21 may be different for a given position of the nozzle 20 based on the bending shape of the bendable conduit 30.

In one embodiment, the nozzle positioning controller 82 may determine the position and orientation of the nozzle 20 based on feedback received from the driving mechanisms 80 without the use of sensors. The nozzle positioning controller 82 may determine the position of the nozzle 20 with reference to the physical dimensions of the nozzle 20 and a point on the nozzle 20, such as a nozzle tip 23 at the intersection of the nozzle axis 22 and a plane perpendicular to the nozzle axis 22 at the nozzle outlet 21.

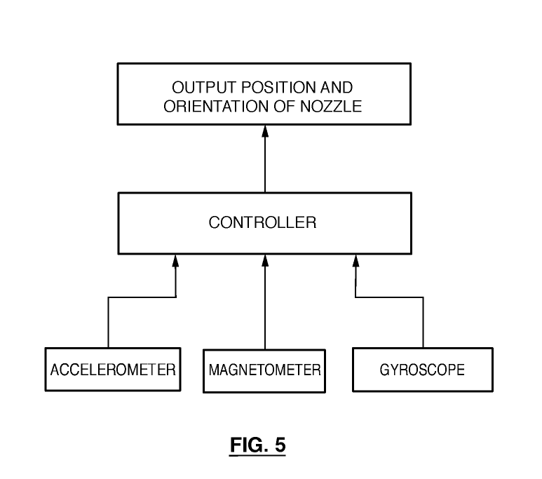

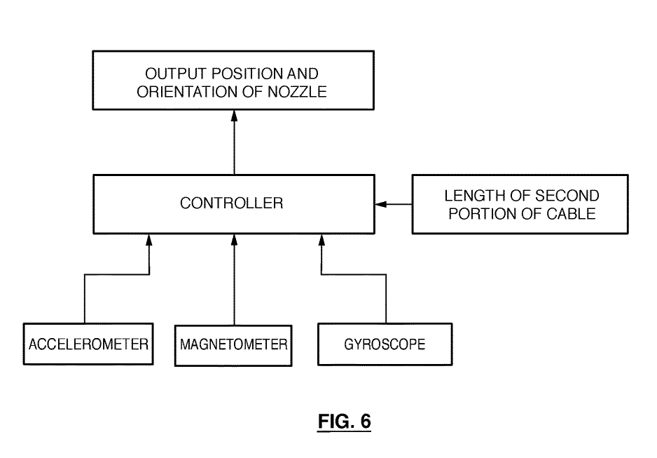

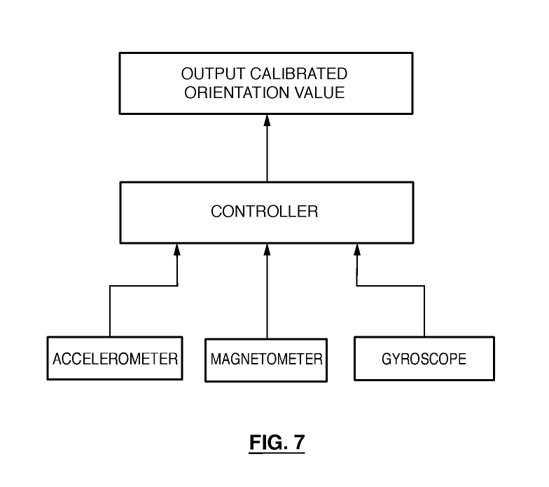

Referring now to FIGS. 5-7, in an embodiment, the articulated nozzle system 10 may comprise a plurality of sensors 83 for tracking the nozzle 20. The sensors 83 may be configured to transmit sensor signals to the nozzle positioning controller 82. The nozzle positioning controller 82 may be configured to receive the sensor signals and determine the position and orientation of the nozzle 20 based, at least in part, on the sensor signals. The nozzle positioning controller 82 may also use the effective length of at least one of the cables to determine the position and orientation of the nozzle 20. The nozzle positioning controller 82 may determine the position of the nozzle 20 with reference to the physical dimensions of the nozzle 20 and a point on the nozzle 20, such as a nozzle tip 23 at the intersection of the nozzle axis 22 and a nozzle outlet plane 24 perpendicular to the nozzle axis 22 at the nozzle outlet 21.

Determining a position and orientation of the nozzle 20 may be more accurate with the use of sensors 83 than without them, as the bending of the bendable conduit 30 may lead to inaccuracies in other methods of determining the position and orientation of the nozzle 20. Use of sensors 83 to determine position and orientation of the nozzle 20 can be very useful in embodiments where the driving mechanisms 80 provide less accurate positional feedback.

In one embodiment, the plurality of sensors 83 may comprise an inertial measurement unit (IMU) package. The IMU package may comprise three compasses, three gyroscopes and three accelerometers. Each sensor may correspond to one of three orthogonal axes (for example: x, y, z or roll, pitch and yaw) in a three-dimensional coordinate system.

The IMU package can be mounted onto the nozzle 20, at any location on the nozzle 20. The accelerometers and the gyroscopes may measure acceleration and orientation values, respectively. The nozzle positioning controller 82 can then calculate the position of the nozzle 20 based on the data from the accelerometers. The IMU package can sense the position and orientation of the nozzle 20 and transmit this information to the nozzle positioning controller 82.

In another embodiment, the nozzle 20 may comprise at least one target mounted on the nozzle 20, at any location on the nozzle 20. The at least one target may be tracked by sensors 83 to provide data to the nozzle positioning controller 82 regarding the position, orientation, velocity, and acceleration of the nozzle 20. In one embodiment, the sensors 83 may be cameras, or optical sensors, which track the target.

Once the position and orientation of the nozzle 20 are determined, the nozzle positioning controller 82 may move the nozzle 20 by actuating the driving mechanisms 80, thereby applying forces to the nozzle 20 so as to tilt and rotate the nozzle 20, and bend the bendable conduit 30.

In order to determine a given position and orientation of the nozzle 20, the articulated nozzle system 10 must be initially calibrated. Initial calibration of the nozzle 20 may be accomplished by manually aligning the nozzle 20 during installation with a pre-determined initial position and orientation of the nozzle 20. In an alternative embodiment, initial calibration of the nozzle 20 may be accomplished by manually aligning the nozzle 20 during installation, and recording the initial position and orientation of the nozzle 20 in the nozzle positioning controller 82. This process may need to be repeated over the lifespan of the articulated nozzle system 10.

Alternatively, initial calibration of the nozzle 20 may be accomplished by moving the nozzle 20 to a pre-determined position and orientation during installation, and recording the sensor signals received by the nozzle positioning controller 82. In an alternative embodiment, initial calibration of the nozzle 20 may be accomplished when the nozzle positioning controller 82 receives sensor signals from the sensors 83 during installation.

In one embodiment, the nozzle positioning controller 82 may be configured to compare the signals received from the magnetometers with the signals received from the gyroscopes in order to calibrate the orientation of the nozzle 20.

The nozzle positioning controller 82 can use the information from the sensors 83 to continuously or periodically calibrate the nozzle 20 with respect to itself. In one embodiment, the nozzle positioning controller 82 may be configured to calibrate the nozzle 20 by comparing the magnetometer sensor signal with the gyroscope sensor signal.

The nozzle positioning controller 82 can also control the supply of fluid to the nozzle 20 and the supply of power to a spot light that can be mounted onto the nozzle 20, or elsewhere within the articulated nozzle system 10. The nozzle positioning controller 82 may comprise a processor and a memory that may include a program for controlling and programming all of the functions described herein.

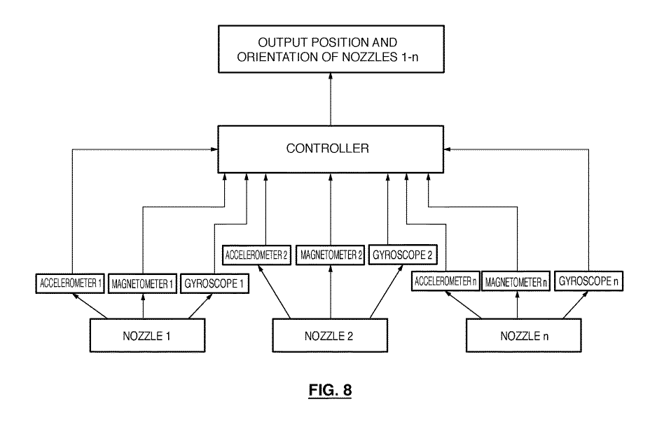

Referring now to FIG. 8, in another embodiment, a fountain installation may include a plurality of articulated nozzle systems 10. Each articulated nozzle system 10 may be operated by an individual nozzle positioning controller 82, and a plurality of articulated nozzle systems 10 may be controlled in concert by a fountain controller to create visually interesting effects. The fountain controller may also operate a plurality of other fountain elements in addition to the articulated nozzle systems 10. For example, a fountain may incorporate additional lighting effects, music, and stationary and moving nozzles.

The fountain controller can continuously or periodically calibrate the nozzle 20 with respect to the other nozzles 20 in the fountain based on the initially calibrated position and orientation of each nozzle 20, and based on the continuously or periodically determined position and orientation of each nozzle 20. The fountain controller may be configured to calibrate and determine the position and orientation of each nozzle 20 in the fountain installation in accordance with the methods herein described with reference to the nozzle positioning controller 82. Calibrating with other nozzles 20 in the fountain may include ensuring that all of the nozzles 20 are pointing in the same direction when they are supposed to do so.

The fountain controller may further be configured to move each nozzle 20, in the manner described herein with reference to the nozzle positioning controller 82, based on the determined position and orientation of that nozzle 20 and at least one other nozzle 20 in the fountain installation.

It will be understood that other variations and modifications of the invention are possibly. All such modifications and variations are believed to be within the sphere and scope of the invention as defined by the claims appended hereto.

1. An articulated nozzle system, comprising:
a bendable conduit for providing a bendable fluid flow path, the bendable fluid flow path i) having a central axis, ii) being bendable such that the central axis is bendable to define curves in non-parallel planes at different portions along a bendable portion of the bendable fluid flow path, and iii) having an upstream end and a downstream end, the upstream end comprising a fluid coupler for coupling the upstream end to a fluid source to receive a fluid flow from the fluid source;
a nozzle for receiving the fluid flow from the bendable fluid flow path and for providing a nozzle fluid flow path in fluid communication with the bendable fluid flow path, the nozzle having a first end and a second end, the first end being mounted to the downstream end of the bendable fluid flow path, wherein the nozzle comprises
a nozzle axis extending between the first end and the second end of the nozzle, wherein the nozzle axis is coincident with the central axis at the first end of the nozzle,
a nozzle outlet at the second end of the nozzle, the nozzle outlet defining a nozzle outlet plane perpendicular to the nozzle axis, the nozzle axis defining a nozzle fluid flow path direction at the nozzle outlet plane, wherein the fluid flow exits the nozzle outlet in the nozzle fluid flow path direction, and
a nozzle tip at the intersection point of the nozzle axis and the nozzle outlet plane; and
a nozzle positioning controller for moving the nozzle by i) rotating the nozzle around a first axis, ii) pivoting the nozzle by an angle of deflection from the first axis, the angle of deflection being measurable in a plane orthogonal to a plane of rotation of the nozzle around the first axis, and iii) bending the bendable fluid flow path, such that any given position of the nozzle tip and the nozzle fluid flow path direction are definable as a combination of the deflection and rotation of the nozzle and the bending of the bendable portion of the bendable fluid flow path.

2. The articulated nozzle system according to claim 1, further comprising:
a plurality of sensors for tracking the nozzle and configured to transmit sensor signals to the nozzle positioning controller, wherein the nozzle positioning controller is configured to i) receive the sensor signals, ii) determine the position of the nozzle tip and the nozzle fluid flow path direction based, at least in part, on the sensor signals, and iii) move the nozzle based on the determined position of the nozzle tip and the determined nozzle fluid flow path direction.

3. The articulated nozzle system according to claim 1, wherein the bendable conduit is a flexible conduit that is bendable at any point along a bendable portion of its length.

4. The articulated nozzle system according to claim 1 or 2, wherein the nozzle positioning controller comprises:
at least three driving mechanisms; and
a plurality of connectors;
wherein one end of each connector is coupled to one of the at least three driving mechanisms, and the other end of each connector is coupled to the nozzle, and each connector is coupled to a different one of the at least three driving mechanisms.

5. The articulated nozzle system according to claim 4, wherein the plurality of connectors are cables.

6. The articulated nozzle system according to claim 4, wherein each of the plurality of connectors are push rods.

7. The articulated nozzle system according to claim 4, wherein the connectors are offset from each other in a circumferential direction around the nozzle axis at the nozzle.

8. The articulated nozzle system according to claim 7, wherein the connectors are positioned relative to each other to apply corresponding forces to the nozzle that are offset by about 120 degrees.

9. The articulated nozzle system according to claim 5, wherein each of the at least three driving mechanisms comprises a spool, and each of the plurality of cables has a first portion and a second portion, wherein
the first portion of each cable is wrapped around the spool of the driving mechanism to which it is coupled,
the second portion of each cable extends between the spool and the nozzle, and
the driving mechanisms are operable to change a length, a rate of change of length, and a rate of rate of change of length of the second portion of each cable.

10. The articulated nozzle system according to claim 9, wherein the nozzle positioning controller is configured to operate the driving mechanisms to determine the length, the rate of change of length, and the rate of rate of change of length of the second portion of each cable, the length, the rate of change of length, and the rate of rate of change of length of the second portion of each cable being definable such that any one or more of the length, the rate of change of length, and the rate of rate of change of length of the second portion of any one of the plurality of cables is different than the length, the rate of change of length, and the rate of rate of change of length of the second portion of any other of the plurality of cables.

11. The articulated nozzle system according to claim 6, wherein each driving mechanism is operable to change a position, a velocity, and an acceleration of each push rod.

12. The articulated nozzle system according to claim 11, wherein the nozzle positioning controller is configured to operate the driving mechanisms to determine the position, the velocity, and the acceleration of each of the plurality of push rods, the position, the velocity, and the acceleration of each push rod being definable such that any one or more of the position, the velocity, and the acceleration of any one of the plurality of push rods is different than the position, the velocity, and the acceleration of any other of the plurality of push rods.

13. The articulated nozzle system according to claim 1, wherein the articulated nozzle system is configured such that a maximum angle of deflection of the nozzle from the first axis is about 50°.

14. The articulated nozzle system according to claim 2, wherein
the sensor signals comprise at least one magnetometer reading, at least one gyroscopic reading and at least one accelerometer reading;
the plurality of sensors comprises at least one magnetometer for measuring the at least one magnetometer reading, at least one gyroscope for measuring the at least one gyroscopic reading, and at least one accelerometer for measuring the at least one accelerometer reading; and,
the nozzle positioning controller is configured to determine the position of the nozzle tip and the nozzle fluid flow path direction based on the at least one magnetometer reading, the at least one gyroscopic reading, and the at least one accelerometer reading.

15. The articulated nozzle system according to claim 14, wherein the nozzle positioning controller is configured to compare the at least one magnetometer reading with the at least one gyroscopic reading and the at least one accelerometer reading to calibrate the nozzle fluid flow path direction.

16. The articulated nozzle system according to claim 1, wherein the nozzle positioning controller is operable such that different nozzle fluid flow path directions are definable for a given position of the nozzle tip by bending the bendable portion of the bendable fluid flow path into different configurations.

17. The articulated nozzle system according to claim 9, wherein the plurality of sensors are mounted on the nozzle, and the nozzle positioning controller is operable to determine the position of the nozzle tip and the nozzle fluid flow path direction based in part on, for at least one cable in the plurality of cables, a length of the second portion of that cable.

18. A fluid display system, comprising:
a plurality of articulated nozzle systems according to claim 2; and
a fluid display system controller, wherein
the fluid display system controller is configured to: i) receive the sensor signals from each of the plurality of articulated nozzle systems, ii) determine the position of the nozzle tip and the nozzle fluid flow path direction of each of the plurality of articulated nozzle systems based, at least in part, on the sensor signals of that articulated nozzle system, and iii) move the nozzle of each of the plurality of articulated nozzle systems based on the determined position of that nozzle tip and the determined position of at least one other nozzle tip, and based on the determined nozzle fluid flow path direction of that articulated nozzle system and the determined nozzle fluid flow path direction of at least one other articulated nozzle system.

19. A method of producing a fluid display, comprising:
providing a bendable fluid flow path, the bendable fluid flow path i) having a central axis, ii) being bendable such that the central axis is bendable to define curves in non-parallel planes at different portions along a bendable portion of the bendable fluid flow path, and iii) having an upstream end and a downstream end;
providing a nozzle fluid flow path with a first end and a second end, the first end of the nozzle fluid flow path being in fluid communication with the downstream end of the bendable fluid flow path, the nozzle fluid flow path having
i) a nozzle fluid flow path axis extending between the first end and the second end of the nozzle fluid flow path, wherein the nozzle fluid flow path axis is coincident with the central axis at the first end of the nozzle fluid flow path,
ii) a nozzle fluid flow path outlet at the second end of the nozzle fluid flow path, the nozzle fluid flow path outlet defining a nozzle fluid flow path outlet plane perpendicular to the nozzle fluid flow path axis, the nozzle fluid flow path axis defining a nozzle fluid flow path direction at the nozzle fluid flow path outlet plane, and
iii) a nozzle fluid flow path tip at the intersection point of the nozzle fluid flow path axis and the nozzle fluid flow path outlet plane;
connecting the upstream end of the bendable fluid flow path to a fluid source;
providing a fluid flow from the fluid source to the nozzle fluid flow path outlet via the bendable fluid flow path and the nozzle fluid flow path, wherein the fluid flow exits the nozzle fluid flow path outlet in the nozzle fluid flow path direction; and,
moving the nozzle fluid flow path, wherein moving the nozzle fluid flow path comprises
i) rotating the nozzle fluid flow path axis around a first axis,
ii) pivoting the nozzle fluid flow path axis by an angle of deflection from the first axis, the angle of deflection being measurable in a plane orthogonal to a plane of rotation of the nozzle fluid flow path axis around the first axis, and
iii) bending the bendable fluid flow path,
such that any given position of the nozzle fluid flow path tip and the nozzle fluid flow path direction are definable as a combination of the deflection and rotation of the nozzle fluid flow path axis and the bending of the bendable portion of the bendable fluid flow path.

20. The method according to claim 19, further comprising the steps of
determining a position of the nozzle fluid flow path tip and the nozzle fluid flow path direction; and,
moving the nozzle fluid flow path based on the determined position of the nozzle fluid flow path tip and the determined nozzle fluid flow path direction.

21. The method according to claim 19, wherein a maximum angle of deflection of the nozzle fluid flow path axis from the first axis is about 50°.

22. The method according to claim 19, wherein different nozzle fluid flow path directions are definable for a given position of the nozzle fluid flow path tip by bending the bendable portion of the bendable fluid flow path into different configurations.

23. A method of producing a fluid display, comprising:
providing a plurality of bendable fluid flow paths, each bendable fluid flow path i) having a central axis, ii) being bendable such that the central axis is bendable to define curves in non-parallel planes at different portions along a bendable portion of the bendable fluid flow path, and iii) having an upstream end and a downstream end;
providing a plurality of nozzle fluid flow paths with a first end and a second end, the first end of each nozzle fluid flow path being in fluid communication with the downstream end of one of the bendable fluid flow paths, each nozzle fluid flow path having
i) a nozzle fluid flow path axis extending between the first end and the second end of the nozzle fluid flow path, wherein the nozzle fluid flow path axis is coincident with the central axis at the first end of the nozzle fluid flow path,
ii) a nozzle fluid flow path outlet at the second end of the nozzle fluid flow path, the nozzle fluid flow path outlet defining a nozzle fluid flow path outlet plane perpendicular to the nozzle fluid flow path axis, the nozzle fluid flow path axis defining a nozzle fluid flow path direction at the nozzle fluid flow path outlet plane, and
iii) a nozzle fluid flow path tip at the intersection of the nozzle fluid flow path axis and the nozzle fluid flow path outlet plane;
connecting the upstream end of each bendable fluid flow path to a fluid source;
providing a fluid flow from the fluid source to each nozzle fluid flow path outlet via the bendable fluid flow path and the nozzle fluid flow path, wherein the fluid flow exits each nozzle fluid flow path outlet in the nozzle fluid flow path direction of that nozzle fluid flow path;
determining a position of each nozzle fluid flow path tip and each nozzle fluid flow path direction; and,
moving each nozzle fluid flow path based on the determined position of that nozzle fluid flow path tip and the determined position of at least one other nozzle fluid flow path tip, and based on the determined nozzle fluid flow path direction of that nozzle fluid flow path and the determined nozzle fluid flow path direction of at least one other nozzle fluid flow path, wherein moving each nozzle fluid flow path comprises
i) rotating the nozzle fluid flow path axis around a first axis,
ii) pivoting the nozzle fluid flow path axis by an angle of deflection from the first axis, the angle of deflection being measurable in a plane orthogonal to a plane of rotation of the nozzle fluid flow path axis around the first axis, and
iii) bending the bendable fluid flow path,
such that any given position of each nozzle fluid flow path tip and each nozzle fluid flow path direction are definable as a combination of the deflection and rotation of each nozzle fluid flow path axis and the bending of the bendable portion of each bendable fluid flow path.

24. The method according to claim 23, further comprising the step of calibrating the position of each nozzle fluid flow path tip and each nozzle fluid flow path direction by moving each nozzle fluid flow path such that each nozzle fluid flow path tip is positioned at a pre-determined nozzle fluid flow path tip position, and each nozzle fluid flow path direction is oriented at a pre-determined nozzle fluid flow path direction orientation.
